(19) United States
(12) Patent Application Publication
(10) Pub. No.: US 2011/0048422 A1
(43) Pub. Date: Mar. 3, 2011

(54) Variable Exhale Scuba Mouthpiece

(76) Inventor: Richard L. Millard, Colorado Springs, CO (US)

(21) Appl. No.: 12/484,231

(22) Filed: Jun. 14, 2009

Related U.S. Application Data
(60) Provisional application No. 61/074,631, filed on Jun. 21, 2008.

(51) Int. Cl. A62B 9/02

(52) U.S. Cl. 128/205.24

(57) ABSTRACT

A mouthpiece for use in underwater Scuba application, exhibiting a variable-position exhaust flow valve, controllable by the user. The user alters the size of the valve opening during exhale, in order to more easily maintain and control the air pressure within the respiratory system. This increased control reduces the need for compensation by the respiratory muscles (ie. diaphragm, intercostals), thus reducing diver fatigue and increasing diver endurance.

REFERENCES CITED

U.S. Pat. No. 3,101,732

U.S. Pat. No. 3,938,511

U.S. Pat. No. 4,031,888

U.S. Pat. No. 4,140,113

U.S. Pat. No. 4,267,832

U.S. Pat. No. 4,699,137

U.S. Pat. No. 5,031,611

U.S. Pat. No. 5,259,374

U.S. Pat. No. 5,305,741

U.S. Pat. No. 5,379,762

U.S. Pat. No. 5,881,718

U.S. Pat. No. 5,970,977

U.S. Pat. No. 6,253,763

U.S. Pat. No. 6,283,122

U.S. Pat. No. 6,354,291

U.S. Pat. No. 6,354,291

U.S. Pat. No. 6,786,216

U.S. Pat. No. 6,966,319

U.S. Pat. No. 7,013,895

### FEDERAL SPONSORSHIP

The invention was made neither by an agency of the United States Government, nor under a contract with an agency of the United States Government.

### FIELD OF THE INVENTION

This invention relates to the field of underwater diving, using the system commonly referred to as Self Contained Underwater Breathing Apparatus (SCUBA). The common SCUBA setup includes: a user-transported tank reservoir containing approximately 3000 psi compressed air, a first-stage regulator to provide approximately 150 psi air from the tank to a supply hose, a supply hose to connect the tank to the second-stage regulator, a second stage regulator placed in front of the user's mouth (to reduce the supply hose pressure to normal atmospheric breathing pressures of approximately 7 psi), and a mouthpiece attached to the second stage regulator to allow the user to hold the regulator in place, as well as to transfer air from the regulator to the user's respiratory system.

The second stage regulator most often contains a two-position air intake valve and a two-position exhalation valve; the two positions of the valve being either opened or closed (or activated/deactivated). The valves allow the passage of air when activated. Previous art has provided for valves that allow for some adjustment of the amount of air when activated, based on diver depth or desired internal pressure. But this adjustment most often includes a finite adjustment across a lengthy time period, not a variable adjustment within the span of a single breath. This previous art often requires the user to manipulate a set-screw or lever on an external portion of the second-stage regulator housing in order to vary the amount of air that will pass to or from the user. This type of step input has shown to increase diver respiratory efficiency, decreasing fatigue. However, further significant gains can yet be made through this invention, by altering the passage of air within a single breath, accounting for continually changing environmental and physiological conditions.

The gains made by this invention center mainly on the exhalation of air by the SCUBA user and the effort required by the user's respiratory system in order to slowly expel the air. In order to maximize the time below the surface of the water, and thus the enjoyment or utility taken from the dive, divers learn to control their breathing rate and technique. The most common technique includes a relatively short period of time to intake the air from the second-stage regulator, but a relatively long period of time to exhale the same air through the regulator. Divers are often taught to never hold their breath, in order to prevent lung expansion injuries. As such, a relatively long exhalation period necessitates that the diver release only a small amount of air in a continual fashion. But, as previous art has provided, non-variable exhalation ports often provide a much larger opening than would normally be needed to most efficiently exhale this small amount of air. Due to the overly-large exhalation port, a much lower air pressure is available within the user's respiratory system, requiring the respiratory muscles to compensate, increasing fatigue. As one would normally do without a second-stage regulator placed in the mouth, in order to relax the respiratory muscles, one would purse the lips to reduce the exhalation area, when required to release a small amount of air. Since the removal of the second-stage regulator is impractical for each exhalation cycle while using the SCUBA system, a variable area exhaust valve would offer solution to the problem at hand.

### BACKGROUND OF THE INVENTION

Previous art relating to this invention make use of three distinct developments:

1. Variable inlet (inhalation-only, not for exhalation) valves for use in Scuba application;

2. Customizable mouthpieces promoting utility, safety, and comfort, for multiple application;

3. One-way exhaust exhalation valves for use in medical application.

Each of these three developments add utility to previous art, but do not account for the exhalation effort required at the varying environmental and physiological conditions encountered during scuba activity. The variable inlet art has dramatically reduced the effort required for inhalation, including at varying conditions, but makes no effort to account for the exhale portion of the user's respiration cycle (see U.S. Pat. Nos. 4,796,618, 5,259,374, 5,379,762, 5,549,107, 5,660,502, 5,678,541, 5,881,718, 5,970,977). The variable inlet art may easily be incorporated into a design using the variable exhaust functions mentioned herein.

The customizable mouthpieces increase physiological comfort and effectiveness while engaged in scuba activity, but makes no attempt to address the aforementioned exhalation effort (see U.S. Pat. Nos. 3,107,667, 3,844,281, 3,929,548, 4,136,689, 4,031,888, 5,031,611, 5,048,519, 5,305,741, 6,079,411, 6,536,424, 6,966,319). As well, the customizable mouthpieces may also be incorporated into a design using the variable exhaust functions mentioned herein.

The one-way exhalation valves (currently adapted for use in medical application) do offer a decrease in the effort required for user exhalation, however, previous art only allows for a two-stage embodiment of the exhaust valve of either fully open or fully closed (see U.S. Pat. Nos. 6,283,122, 6,786,216, 7,013,895). This embodiment does not allow for user-controlled adjustment based on variations of environmental or physiological conditions within a single breath.

### SUMMARY OF THE INVENTION

One presently preferred embodiment and one alternative embodiment exist for a variable exhaust scuba mouthpiece for use in underwater application. Both embodiments include a variable exhaust flow valve, controllable by the user. The user alters the size of the valve opening during exhale in order to increase back pressure within the respiratory system, thus reducing fatigue and increasing diver endurance. The preferred embodiment includes a linear spring that holds the opening of the mouthpiece fully open until depressed by the user's teeth or lips. The alternative embodiment includes an iris valve that reduces the opening of the mouthpiece concentrically as depressed by the user's teeth or lips.

### BRIEF DESCRIPTION OF THE DRAWINGS

FIG. 1 is a top view of a presently preferred embodiment and alternate embodiment.

FIG. 2 is a side view of FIG. 1.

FIG. 3 is a front view of FIG. 1 during the open (or deactivated) valve state of a presently preferred embodiment.

FIG. 4 is a front view of FIG. 1 during the closed (or activated) valve state of a presently preferred embodiment.

FIG. 5 is a front view of FIG. 1 during the open (or deactivated) valve state of an alternate embodiment.

FIG. 6 is a front view of FIG. 1 during the closed (or activated) valve state of an alternate embodiment.

### DETAILED DESCRIPTION OF THE INVENTION

The detailed description set forth below in connection with the appended drawings is intended as a description of exemplary embodiments, and is not intended to represent the only forms in which embodiments may be constructed and/or utilized. The description sets forth the functions and the sequence of steps for constructing and operating embodiments. However, it is to be understood that the same or equivalent functions and sequences may be accomplished by different embodiments that are also intended to be encompassed within the spirit and scope of the embodiments disclosed herein.

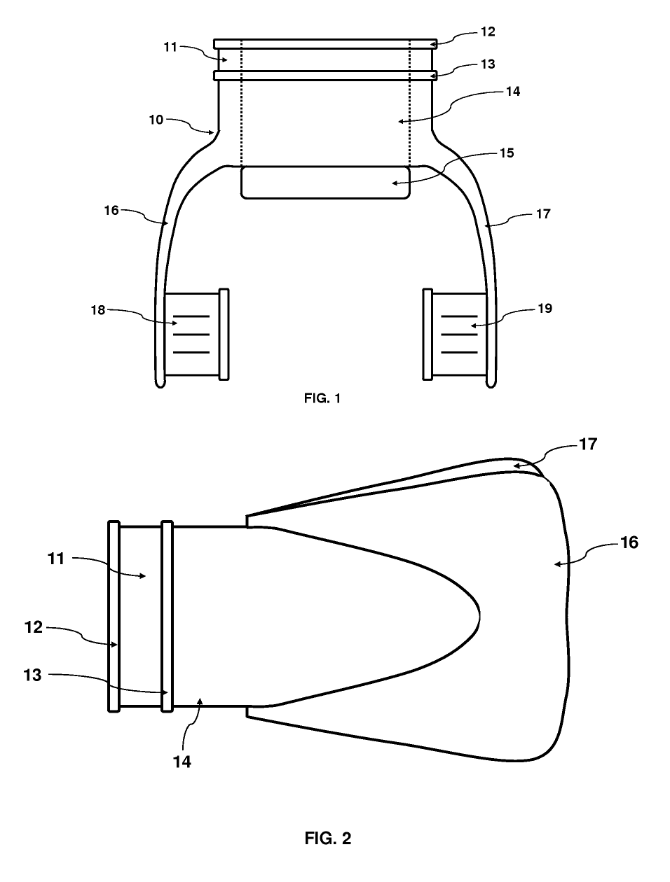

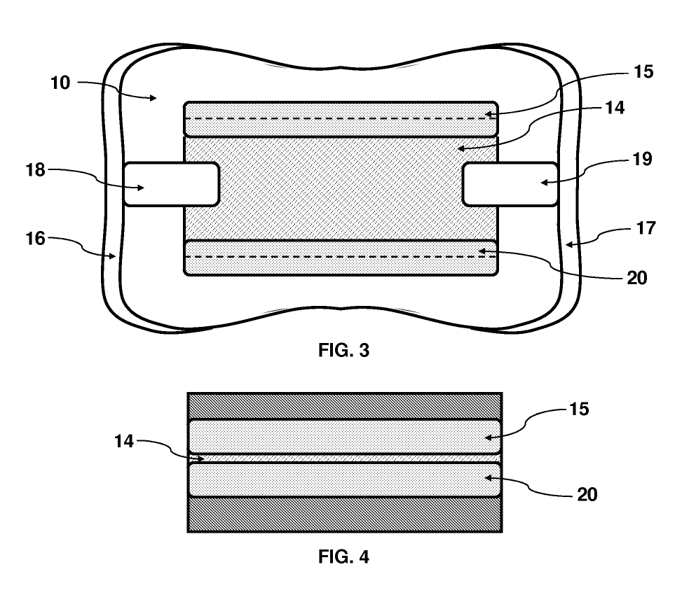

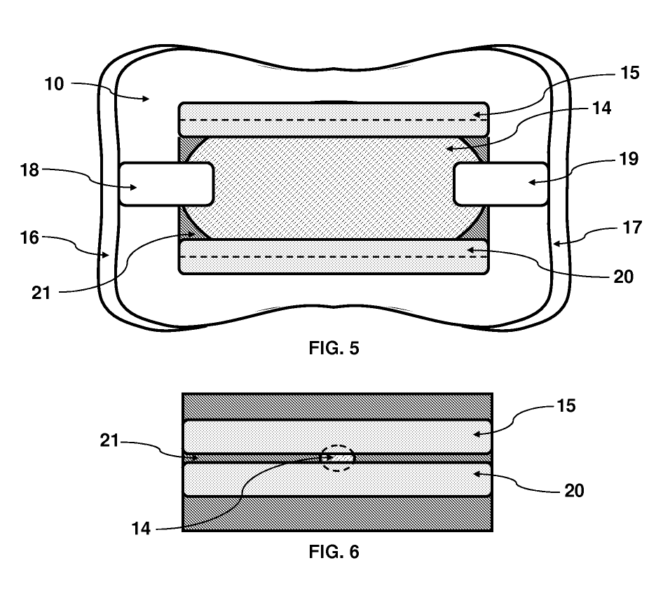

Within the appended drawings, both the presently preferred embodiment and an alternate embodiment share the Top and Side Views found in FIGS. 1 and 2. The presently preferred embodiment uses the linear spring valve system depicted in FIGS. 3 and 4 (for both open and closed states), and the alternate embodiment uses the iris valve system depicted in FIGS. 5 and 6 (for both open and closed states).

Referring to FIG. 1, a flexible housing 10 inserts into the user's mouth, with the user's lips wrapping around the housing prior to ring 13. The housing 10 attaches to the tube directly provided from the second stage scuba regulator. An exterior radial channel 11 at the end of the housing is bounded by raised rings 12 and 13 to allow for compression attached by use of a quick-tie or similar radial fastener. The housing 10 fits over the hollow tube from the regulator with hollow interior linear channel 14. The air to and from the second stage regulator pass through channel 14 to the user. The housing is retained in the mouth of the user by retaining wings 16 and 17, and molar pads 18 and 19. The retaining wings 16 and 17 fit along the inner side of the user's cheeks, and allow the housing to be held in place by the user's lips and mouth. The user compresses the molar pads 18 and 19 with the rear teeth, as well to hold the housing in place. The user alters the amount of air exhaled by varying the position of lever 15. This lever is attached to the valve controlling the area available for the passage of air through channel 14. Upon exhale, the user compresses lever 15, reducing the area available for exhaust, and then releases the valve upon inhale, allowing maximum intake area.

Referring to FIG. 2, the retaining wings 16 and 17 flare out slightly at the end of the mouthpiece, to aid in retaining of the housing by the lips and mouth. The figure further shows that exterior radial channel 11, rings 12 and 13, and hollow interior linear channel 14 are circular/cylindrical in nature.

Referring to FIG. 3, it depicts a front view of the linear spring system included in the presently preferred embodiment. Upper lever 15 and lower lever 20 are shown in the open (or deactivated) position, with the largest opening possible to channel 14 within housing 10. To activate the valve upon exhaust, the user compresses lever 15 with the upper set of teeth, and lever 20 with the lower set of teeth. The conjoinment of these levers closes the valve to channel 14 by compressing a linear spring attaching the levers, existing at either side of the channel 14. Retaining wings 16 and 17, and molar pads 18 and 19 are also shown from the front view. FIG. 4 shows the levers and springs compressed, reducing the exit area for exhaust to channel 14 to the smallest possible. Levers 15 and 20 are conjoined far closer than in the open state depicted in FIG. 3, but not to close off channel 14 completely. This closed (or activated) state allows the air pressure within the respiratory system of the user to increase, thus reducing respiratory muscle fatigue and increasing user endurance. Should an event occur such that the user inadvertently clamps down on levers 15 and 20 in a moment of stress, the valve springs will release, allowing full area for inhale and exhale.

Referring to FIG. 5, it depicts the front view of the iris valve system included in the presently preferred alternate embodiment. As with the linear spring system, the user controls the amount of exhaust passing into channel 14 by adjusting the position of levers 15 and 20 with the teeth. These levers are attached to the iris valve 21. The figure shows the iris valve in the full open (or deactivated) position, allowing the maximum possible area for exhaust to enter channel 14. The retaining wings 16 and 17 and molar pads 18 and 19 are also shown in the front perspective. FIG. 6 shows the iris valve in the closed position, as the user closes (or activates) the valve by conjoining levers 15 and 20. The iris valve 21 is shown in the fully closed position, allowing a much smaller amount of exhaust to reach channel 14, but not closing off the channel completely. Should an event occur such that the user inadvertently clamps down on levers 15 and 20 in a moment of stress, the iris valve will release, allowing full area for inhale and exhale.

I claim:

I. A mouthpiece exhibiting a variable-position exhalation valve, controllable by the user. The user varies the size of the valve opening during exhale, to maintain and adaptively control air pressure within the user's respiratory system.

II. A feature of a variable-position exhalation valve that allows the size of the valve opening to be altered with movement of the user's mouth, forcing the valve closed with the lips or teeth, and a spring or return mechanism opening the valve upon relaxation of the mouth.

III. A safety device incorporated into the mouthpiece that allows for full opening of the valve in the case of a full clenching of the jaw and/or full closing of the user's teeth or lips (such as a rapid movement of the mouth-positioned Scuba regulator or during a stress-inducing event).
